(19) United States
(12) Patent Application Publication
(10) Pub. No.: US 2001/0037242 A1
(43) Pub. Date: Nov. 1, 2001

(54) Method and system for delivering content and direct marketing over a network

(75) Inventors: Marc Bataillon, Boston, MA (US); Jeffrey Glass, Brookline, MA (US)

Correspondence Address: FOLEY, HOAG & ELIOT, LLP, PATENT GROUP, ONE POST OFFICE SQUARE, BOSTON, MA, 02109, US

(73) Assignee: Transactive Solutions, Inc.

(21) Appl. No.: 09/818,821

(22) Filed: Mar. 27, 2001

Related U.S. Application Data
(60) Provisional application No. 60/192,384, filed on Mar. 27, 2000.

(51) Int. Cl. G06F 17/60

(52) U.S. Cl. 705/14; 705/10; 705/26

(57) ABSTRACT

Provided herein is a method and system for delivering content and direct marketing over a network. There is a host system, a vendor system, and a subscriber system connected to a network. A subscriber registers by providing information to the host system. The subscriber then selects topics that the subscriber is interested in from a plurality of topics. The subscriber then receives writings on such topics, along with information on products, services, or entities. Information relating to the subscriber's activities are tracked. This information can be used to target advertisements or product recommendations. This information can also be provided to third parties. Also provided is an ecommerce system wherein a host enters into an agreement with a vendor whereby the host receives compensation as a result of a subscriber viewing an advertisement or purchasing a product or service.

### CLAIM OF PRIORITY

This application claims priority to U.S. Provisional Application Ser. No. 60/192,384, entitled “Method and System for Delivering Content and Direct Marketing Over a Network,” filed on Mar. 27, 2000, naming Marc Bataillon and Jeffrey Glass as inventors, the contents of which are herein incorporated by reference.

### BACKGROUND OF THE INVENTION

1. Field of the Invention

The invention relates generally to a method and system for delivering content and direct marketing over a network.

2. Description of Related Art

There are a number of ways for delivering content and marketing products known in the art. Companies place advertisements, such as banner advertisements, in their webpages, where users that happen across the webpage receive the same advertisements that every other user receives. Companies also engage in permission marketing, where users register their areas of interest and receive product offers and coupons based on this information. An example of this is Yesmail.com. These methods, however, have limited success, because they provide information to users based on little or no information about the users.

Accordingly, it would be desirable to provide a method of direct marketing that is based on information about the user.

### SUMMARY OF THE INVENTION

The invention is directed to a method for delivering content and direct marketing over a network, in particular over the Internet. According to the method, a subscriber provides certain information, such as demographic information, in a registration process. The subscriber also selects certain topics that the subscriber would like to learn more about. The subscriber then receives emails on the selected topics, along with advertising and/or product recommendations relating to the topics. The topic selections made by the subscriber, the subscriber's purchasing habits, and other activities of the subscriber are tracked and recorded. This information is then used to focus advertisements and product recommendations to subscribers. The information may also be provided to third parties so that they can better understand their customers.

Other aspects of the invention will be shown from the following description of the systems and methods herein.

### BRIEF DESCRIPTION OF DRAWINGS

The foregoing and other objects and advantages of the invention will be appreciated more fully from the following further description thereof, with reference to the accompanying drawings wherein;

FIG. 1 is a diagram illustrating one embodiment of the invention;

FIG. 2 depicts a software system suitable for configuring the systems depicted in FIG. 1;

FIG. 3 depicts an example of a writing according to the invention;

FIG. 4 depicts an example of a subscription page according to the invention;

FIG. 100 is a list of webpages of a website that embodies the present invention;

FIGS. 101-107 are webpages listed under “Zooba.com” in FIG. 100;

FIGS. 201-203 are webpages listed under “MyZooba” in FIG. 100; and

FIGS. 301-308 are webpages listed under “Zooba Advantage” in FIG. 100.

### DETAILED DESCRIPTION OF THE PREFERRED EMBODIMENTS

To provide an overall understanding of the invention, certain illustrative embodiments will now be described. However, it will be understood by one of ordinary skill in the art that the methods and systems described herein can be adapted and modified for other suitable applications and that such other additions and modifications will not depart from the scope hereof.

1. System Configuration

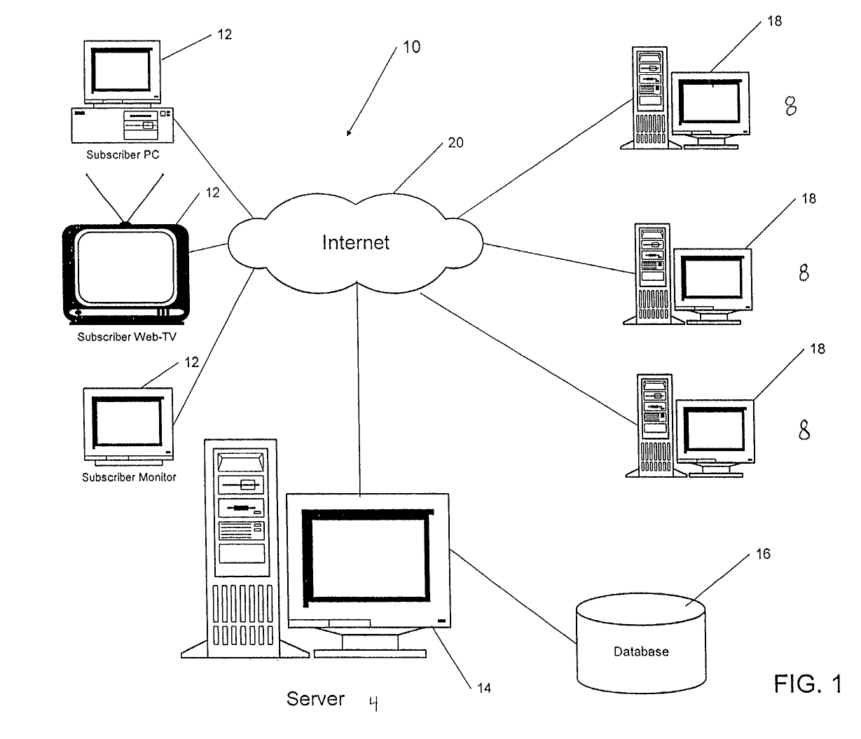

FIG. 1 depicts one embodiment of a system 10 according to the present invention. Specifically, FIG. 1 illustrates a system 10 wherein a plurality of subscriber systems 12 connect through a network 20 to a host system 14. The host system 14 connects to a database 16. The host system 14 and the subscriber systems 12 are connected through the network 20 to a product, service, or advertising vendor system 18. Subscribers 1 can interact with the subscriber systems 12, a host 4 can interact with the host system 14, and a vendor 8 can interact with the vendor system 18. The network 20 may be the Internet, World Wide Web, dedicated channels, secured lines, digital or analog wireless data lines, or any other network that can provide communication links between computer devices.

The elements of the system 10 can include commercially available systems that have been arranged and modified to act as a system according to the invention. The subscriber systems 12 may be personal computers, laptop computers, servers, WebTVs™, pagers, personal digital assistants, cellular phones, or any other devices capable of supporting a connection to the network 20. The host system 14 and the vendor system 18 may be personal computers, laptop computers, servers, or any other devices capable of supporting a connection to the network 20, and may consist of one or more of these devices. The subscriber systems 12, the host system 14, and the vendor system 18 may connect to the network 20 via a network interface card, a telephone line, a wireless data connection, cable, or any other connection.

In an embodiment, the subscriber systems 12 may include graphical user interfaces. Further, the subscriber systems 12 may include browsers for allowing the viewing of files that are transmitted via the Internet or World Wide Web, such as HTML, dynamic HTML, CGI scripts, and other files. Browsers may include the Netscape™ browser, the Microsoft Internet Explorer™ browser, the Lynx™ browser, or any other browser that allows an end-user to exchange data or files with a web server, an ftp server, a gopher server, or any other type of network server. The host system 14 and the vendor system 18 preferably include a server, which, in an embodiment, may be a web server capable of sending and receiving data or files to and from subscriber systems 12 and each other.

The subscriber systems 12 may include a monitor and keyboard. Although the monitor elements depicted in FIG. 1 are shown as CRT monitors of the type employed with a conventional workstation or a television set, it should be apparent to one of ordinary skill in the art that the monitor elements can be LCD displays that can be incorporated into an integrated stand alone unit. Similarly, the keyboards (not shown) may be conventional keyboards that can be employed with a workstation or alternatively may be a keypad of the type commonly employed with dedicated hardware systems. The key pad can provide to an operator the necessary interface for operating a stand alone system. Alternatively, the subscriber systems 12 may utilize an audio interface for entering in commands and data by use of speech recognition software.

The subscriber systems 12, host system 14, and vendor system 18 may rely on a secured or unsecured communication path, such as the Internet or World Wide Web, for communication between these various systems. If it is an unsecured communication path, security can be added by employing a security system, such as any of the conventional security systems that have been developed to provide secured channels for transmitting data over the Internet. One such system is the Netscape™ secured socket layer (SSL) security mechanism that provides a trusted path between a conventional web browser program and a web server. Therefore, the subscriber systems 12, host system 14, and vendor system 18 may have SSL capability for establishing an SSL communication channel between the systems. Other security systems can be employed, such as those described in Bruce Scheir, Applied Cryptography (Addison-Wesley 1996). Alternatively, the systems may employ, at least in part, secure communication paths for transferring information between the server and the client. For purposes of illustration, however, the systems described herein will be understood to employ a public channel, such as an Internet Connection through an Internet Service Provider (ISP) or any other suitable connection, to connect the systems.

The host system 14 and the vendor system 18 may be supported by commercially available server platforms such as a Sun Sparc™ system running a version of the Unix operating system and running a server capable of connecting with, or exchanging data with, one of the subscriber systems 12. In the embodiment of FIG. 1, the host system 14 and the vendor system 18 include a web server, such as the Apache web server or any other suitable web server. The web server component of the host system 14 and the vendor system 18 acts to listen for requests from subscriber systems 12 or the other system, and to in response to such a request, resolves the request to identify a filename, script, dynamically generated data that can be associated with that request and to return the identified data to the requesting subscriber system 12. The operation of the web server component of the host system 14 and the vendor system 18 can be understood more fully from Laurie et al., Apache: The Definitive Guide, O'Reilly Press (1997). The host system 14 and the vendor system 18 may also include components that extend its operation to accomplish certain aspects of the invention described herein, and the architecture of the server 14 may vary according to the application. For example, the web server may have built in extensions, typically referred to as modules, to allow the host system 14 and the vendor system 18 to perform operations that facilitate the activities desired by a subscriber 1, or the web server may have access to a directory of executable files, each of which files may be employed for performing the operations, or parts of the operations, that implement aspects of the invention described herein. Thus it will be understood that the host system 14 and the vendor system 18 may act as a transaction server according to the invention that configures the work station hardware supporting the host system 14 and the vendor system 18 to act as systems according to the invention.

The host system 14 may couple to a database 16 that stores information representative of a subscriber's account, including information such as passwords, user accounts, user privileges, user preferences, demographic data, and similar information. Other information may be recorded as well, such as transaction data, e-commerce data, subscription data, and other similar information. The depicted database 16 may comprise any suitable database system, including the commercially available Microsoft® Access™ database, and can be a local or distributed database system. The design and development of database systems suitable for use with the host system 14, follow from principles known in the art, including those described in McGovern et al., A Guide To Sybase and SQL Server, Addison-Wesley (1993). The database 16 can be supported by any suitable persistent data memory, such as a hard disk drive, RAID system, tape drive system, floppy diskette, or any other suitable system. The system 10 depicted in FIG. 1 includes a database device 16 that is separate from the server station platform 14, however, it will be understood by those of ordinary skill in the art that in other embodiments the database device 16 can be integrated into the host system 14.

In embodiments, the host system 14 and the vendor system 18 may include an application employing an application framework, such as an object-oriented framework. As is known to those of skill in the art, object oriented frameworks are generally understood as a set of classes that embody an abstract design for solutions to a family of related problems. See The C++ Programming Language, 2nd Ed., Stroustrup Addision-Wesley. Accordingly, a framework provides a prefabricated structure, or template, of a working program. For example, for a traditional application program, a framework can provide support and “default” behavior for drawing windows, scroll bars and menus. Optionally, a framework can provide sufficient functionality and wired-in interconnections between object classes to provide an infrastructure for a developer developing services for the host system 14 or the vendor system 18. The interconnections are generally understood to provide the architectural model and design for developers, allowing developers to focus on the problem domain and allowing increased levels of hardware independence, as frameworks can provide to developers abstractions of common communication devices reducing the need to include within a service application hardware dependent code.

The design and development of object oriented frameworks, such as the framework that may comprise an application on the systems described herein follows from principles known in the art of computer science, such as principles set forth in Booch, Grady, “Designing an Application Framework”, Dr. Dobb's Journal 19, No. 2, (February, 1994); Booch, Grady, “Object Oriented Analysis and Design With Applications”, Redwood City, Calif. Benjamin/Cummings (1994); and Taligent, “Building Object Oriented Frameworks”, Taligent, Inc., (1994).

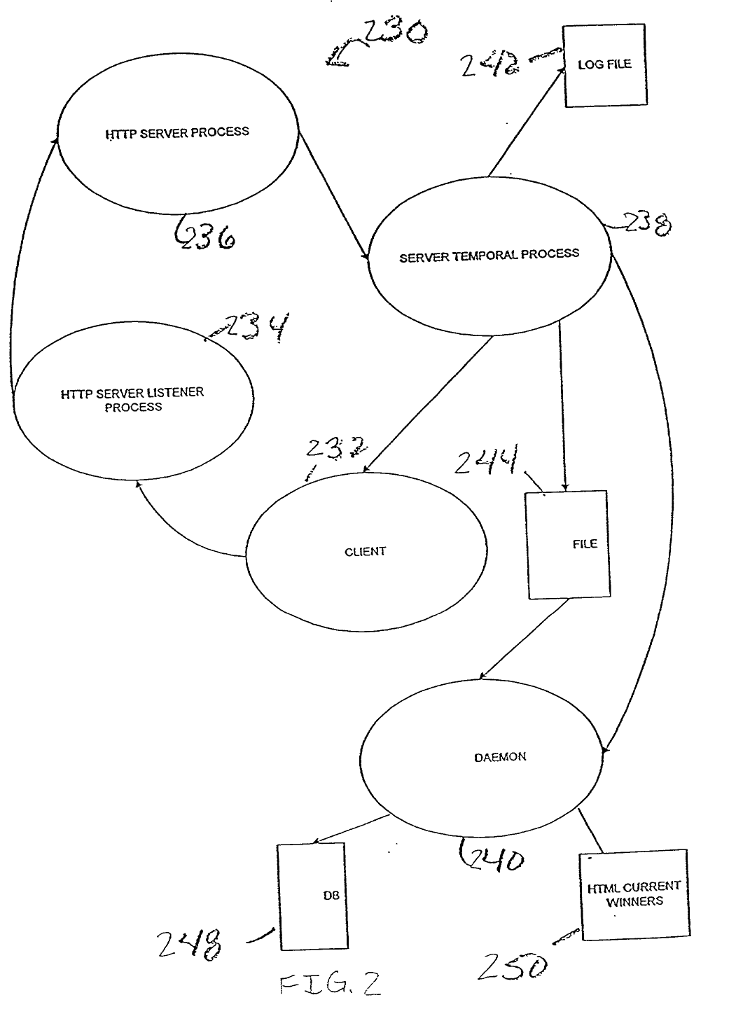

FIG. 2 depicts diagrammatically one embodiment of a software system suitable for configuring the systems depicted in FIG. 1 to operate as a system according to the invention. In particular, FIG. 2 depicts a software system 230 that includes a client process 232, an HTTP server listener process 234, an HTTP server process 236, a server temporal process 238, a daemon 240, a log file 242, a data file 244, a database 248, and an HTML page 250.

The client process 232 can be a computer program operating on the subscriber system 12 such as those depicted in FIG. 1, that are capable of downloading and responding to computer files served by the host system 14. In particular, the client process 232 can be a browser program that is capable of forming one or more connections to an HTTP server process for transferring pages from the HTTP server process to the client process 232. Such a browser process can be the Netscape Navigator™ browser process, the Microsoft Explorer™ browser process, or any other conventional or proprietary browser process capable of downloading pages.

FIG. 2 further depicts that the client process 232 forms one or more connections to the HTTP server listener process 234. The HTTP server process can be any suitable server process including the Apache™ server. Suitable servers are known in the art and are described in Jamsa, Internet Programming, Jamsa Press (1995), the teachings of which are herein incorporated by reference. In one embodiment, the HTTP server process serves HTML pages to client processes making requests for such pages. An HTTP server listener process 234 can be an executing computer program operating on the host system 14 and which monitors a port, typically well-known port 180, and listens for client requests to transfer a resource file, such as a hypertext document, an image, audio, animation, or video file from the server's host to the client process host. In one embodiment, the client process employs the hypertext transfer protocol (HTTP) wherein the client process 232 transmits a file request that specifies a file name, an Internet location (host address), and a method, such as the HTTP, or any other proprietary or standard protocol suitable to retrieve the requested file. The HTTP server listener process detects the client request and passes the request to the executing HTTP server processors, such as the HTTP server process 236. It will be apparent to one of ordinary skill in the art, that although FIG. 2 depicts one HTTP server process, a plurality of HTTP server process can be executing simultaneously. The HTTP server processors can pass the file request typically round-robin style until an HTTP server process is identified that is available to service the client's request.

In an optional embodiment, the HTTP server process that is available to service the request can cause a server temporal process, such as the server temporal process 238, to be forked off. The server temporal process 238 receives the client's request and processes it to generate, or provide, a page signal to be served to the client. In one embodiment, the server temporal process 238 is a non-parsed header CGI script that produces an HTML page that is passed to the client process 232. The client process 232 will decode the page signal and display to the participant.

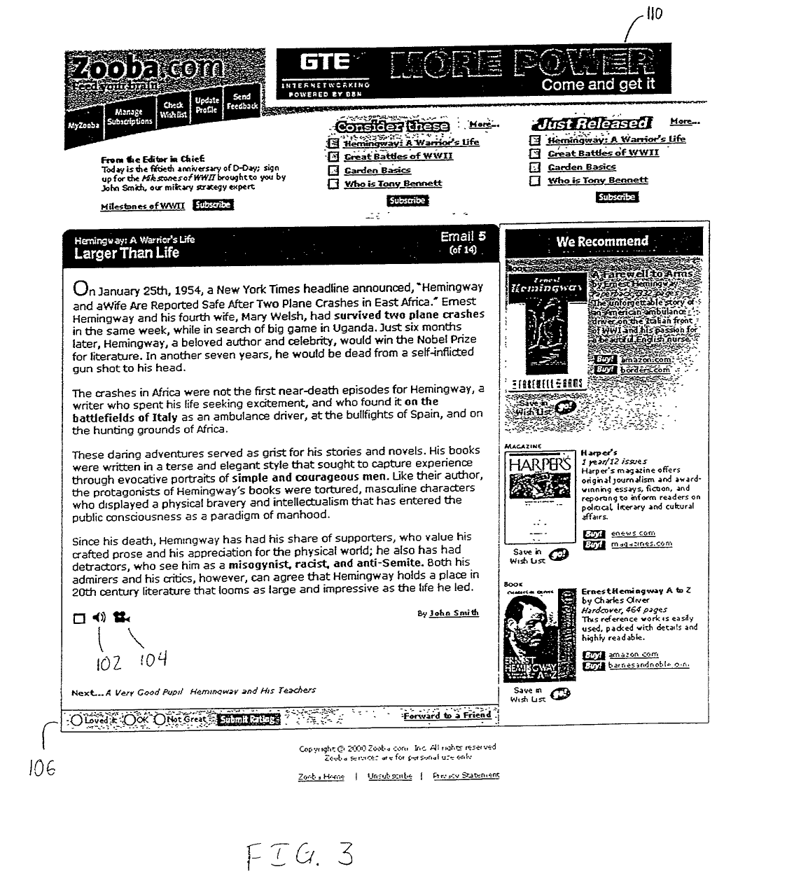

Continuing with the example described above, the HTML page served by the server temporal process 238 to the client process 232 will be processed by the client process 232, the browser program, to generate a graphical image of the page being requested by the subscriber system 12. One such page is depicted in FIG. 3 and will be explained in greater detail hereinafter.

The subscriber 1 can send information to the host system 14 or the vendor system 18 by activating a control, such as a button, on the page to submit, by typing into a form provided by an HTML template, dynamic HTML template, JavaScript, applet or other technique, the relevant information.

The server temporal process 238 can create a log file 242 in which the server temporal process 238 stores a signal that identifies the subscriber 1 that has submitted the information and the information provided by the subscriber 1. The log file 242, or a database, can be generated by a CGI Script or any other suitable technique, including any of the techniques described in Graham, HTML Sourcebook, Wiley Computer Publishing (1997) the teachings of which are herein incorporated by reference. In one practice, the server temporal process 238 directs the storage of this information within the log file 242. Accordingly, the log file 242 can act as a database that stores the various information.

2. Method.

In an embodiment, the subscriber 1 registers with the host system 14 in a registration process. The subscriber 1 provides certain information about himself such as name, address, zip code, age, birthday, interests, income, gender, demographic information, telephone numbers, highest level of education completed, profession, number of people in their home, if they have any children, annual income, interests, hobbies, weight, nationality, and any other information that may be of interest. The subscriber 1 could enter this information into a template and enter a command into the subscriber system 12, which then will send the file to the host system 14. This information could then be stored in the database 16 and in a profile for the subscriber 1. The subscriber 1 might also be allowed to revise the data by, for example, entering his password and the new or revised data into a template that the subscriber 1 then sends to the host system 14, the new information being stored on the database 16 or the host system 14. In alternate embodiments, the steps of registering may be accomplished by way of phone, fax, e-mail, in-person or by any other means of communication.

Series are stored on the database 16 or the host system 14. Series are a series of more than one short writings on a particular topic. For example, a topic could be on the life of Ernest Hemingway or Gardening Basics. In the first example, one writing could relate to Ernest Hemingway's life story, and another on his writing style. In the second example, one writing could be about growing spices, another could be about growing vegetables, and yet another could be about various types of indoor plants. The writings for each Series can be diverse in subject matter; they need only relate to each other in some manner. The number of writings per Series can be as little as two, but more typically is 15 to 20. In a preferred embodiment the length of the writings may be approximately 500 words long, whereas in another preferred embodiment they may be approximately 1,000 words long. Their length will depend on their subject matter and the number of writings in a given Series. An example of a writing is depicted in FIG. 3.

Series can include more than just written words. Series may include graphical images, sound clips, video clips, animated figures and any other form of content that can be communicated over the network 10 and received by subscriber systems 12. Graphical links to sound content 102 and graphical links to video content 104 are shown in FIG. 3.

Series can come from a variety of sources. In one embodiment Series are written based on various sources, or the collected knowledge of the author of the Series, or both. In another embodiment Series are based on a particular book. Such Series could be, for example, a serialization of the book, or a collection of digests or condensations derived from the book. In yet another embodiment, a Series could be based on more than one book.

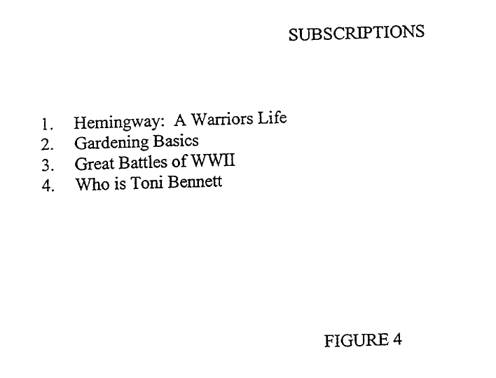

As mentioned previously, Series are stored on the database 16 or the host system 14. In a preferred embodiment, a subscriber 1 can visit a home page on the host system 14. This homepage might then contain a link to a subscription page. Referring to FIG. 4, the subscription page would contain a number of topics which the subscriber 1 could select. Upon selecting a topic, the subscriber 1 would be subscribed to receive a Series on the topic selected. This subscription information would be stored on the database 16 or the host system 14. In a preferred embodiment, the information would be included in the subscriber's 1 profile.

After subscribing to a particular Series, the subscriber 1 will begin to receive the Series. The Series may be delivered from the host system 14 to the subscriber system 12 in a variety of formats. For example, the Series may be sent by electronic mail, or to a personal web page in HTML format, or in any other form that can be received by a subscriber system 12. An example of a personalized web page generally can be found at www.my.yahoo.com.

In an embodiment a subscriber 1 can set certain preferences. For example, the subscriber 1 could set a preference of receiving the Series via electronic mail, personal web page, or another form. The subscriber 1 could select the frequency of the delivery of writings, such as daily, weekly, bi-weekly, or monthly. Alternatively, the subscriber 1 could choose to receive writings on particular days of the week. These preferences could apply to all subscriptions, or on a subscription by subscription basis. Such preferences would be stored on the host system 14 or the database 16, and preferably also in the subscriber's 1 profile.

In a preferred embodiment the subscriber 1 may also be able to modify the subscriber's 1 subscriptions. For example, the subscriber 1 could terminate a subscription to a Series prior to its completion. In addition, the subscriber 1 could change the subscriber's 1 preferences. Such modifications would be stored on the host system 14 or the database 16, and preferably also in the subscriber's 1 profile. Information stored may include whether and when a subscriber 1 unsubscribes to a Series.

The invention may also include a method for providing feedback by the subscriber 1. In a preferred embodiment each writing provides a form that can be filled out by the subscriber 1 after viewing the writing. This form can consist of a response electronic mail where a subscriber 1 can provide written feedback or a check the box form 106 (as shown in FIG. 3) where the subscriber 1 can rank the writing on a scale, such as “loved it,” “ok,” “not great,” or “bad.” Theses responses preferably will be stored on the database 16 or the host system 14, and also in the subscriber's 1 profile.

In another embodiment, Odysseys are stored on the database 16 or the host system 14. Odysseys, like Series, are a series of more than one short writings on a particular topic. Odysseys are focused on very broad topics, such as art, science, politics, business, etc. Odysseys include multiple writings, and may be sent to the subscriber 1 on an ongoing basis. Alternatively, Odysseys may be sent to subscribers 1 in a limited number of writings. In an embodiment, a subscriber 1 when registering or modifying the subscriber's 1 profile, selects to subscribe to particular a Odyssey topic. Upon selecting an Odyssey topic, the subscriber 1 would be subscribed to receive an Odyssey on the selected topic. The subscription information would be stored on the database 16 or the host system 14, and in a preferred embodiment the information would be included in the subscriber's 1 profile. In a preferred embodiment, a writing in an Odyssey will give the subscriber 1 the option to learn more about the subject matter which is presented in the Odyssey writing. In such case, the subscriber 1 will be given the option to subscribe to a Series on such subject matter. Unless otherwise stated herein, discussions of Series apply with the same force and effect to Odysseys.

Advertising can be included in Series writings. These advertisements may be banner advertisements on the top or bottom of the writing or placed elsewhere in or around the writing. A banner advertisement 110 is shown in FIG. 3. They can advertise products, services, and promote companies, non-profit corporations, and other entities generally, as well as other forms of advertising and promotion. They can include graphics, audio, and video and any other form of content distributable over the network 20. Such advertisements may include co-branded Series or writings, or private labeled Series or writings. Advertisements may also include hypertext links to servers and systems connected to the network 10, including vendor systems 18.

The Series and writings may include specific product and service recommendations. As mentioned above, in a preferred embodiment the Series is based on a particular book. An advertisement for that book can be included in one or more of the writings of that Series. Also, as mentioned above, the Series may be based on more than one particular book. In such case, advertisements for one or more such books can be included in one or more of the writings of that Series. In another embodiment, books, other products, and services relating to the topic of the Series can be advertised or promoted in one or more of the writings in the Series.

In a preferred embodiment advertisements contain links to vendor systems 18 which contain web pages or other files that contain additional information relating to the advertisement. In the case of product and service recommendations, the link may be to a vendor system 18 where the subscriber 1 can purchase the advertised book, other product, or service.

Various activities of the subscribers 1 may be tracked and stored. For example, if a subscriber 1 activates an advertisement link, a communication may be sent to the host system 14 that such an action was taken by the subscriber. The subscriber may be indicated by an account number or by another identifier in the communication. The advertisement may be identified by a specific advertisement reference number or by another identifier in the communication. Additional information may be recorded as well, such as the date and the time of day of the activation of the link. This information then could be stored on the host system 14 or the database 16. In a preferred embodiment, the information would be stored in the subscriber's profile. There are a multitude of methods for targeting advertisements and tracking user activities known in the art, some of which are described in U.S. Pat. No. 5,948,061 (Method of Delivery, Targeting, and Measuring Advertising Over Networks).

In a preferred embodiment, the host 4 enters into an agreement with a vendor 8 that sell goods and/or services. A vendor 8 can be any entity, such as a corporation, non-profit corporation, or a person or persons. The vendor 8 may or may not be a publisher, owner, or author of a book upon which a Series is based. These agreements may establish a relationship between the host 4 and the vendor 8 whereby, if a subscriber 1 executes a hyperlink contained in an advertisement, and subsequently purchases a product or service, the vendor 8 will either directly or indirectly compensate the host 4. This compensation could be based on a percentage of the price for which the item(s) was sold, a flat fee, or any other compensation arrangement.

A host 4 could also enter into an agreement with a vendor 8 whereby it would be compensated by the vendor 8 by virtue of a subscriber 1 executing a hyperlink contained in an advertisement. Such compensation could be based on a per execution fee or otherwise.

If a subscriber 1 purchases a product or service from a vendor 8, the information relating to the transaction may be transmitted to the host server 14. Such information may include the amount of the purchase, the date of the purchase, the time of day of the purchase, and the item purchased. This information could then be stored on the host server 14 or the database 16, and preferably would be included in the subscriber's 1 profile. Also, information as to what hyperlinks contained in advertisements are executed by subscribers can be stored, regardless of whether the subscriber 1 purchases anything. Further, any means of tracking end-user activity can be utilized, and resulting information stored.

Information relating to subscribers can be gathered in various ways. First, as discussed above, certain information can be requested in a registration process. Second, information on subscriber activities can be gathered. As discussed above, the advertising links that a subscriber executes and the purchasing activities of the subscribers 1 can be recorded. Information ancillary to such activities can be collected and stored, such as the time and date of the activities. Third, information added to or modified in the subscribers' profiles can be recorded and stored. As discussed above, this information might include, to what Series a subscriber subscribes, whether and when a subscriber 1 unsubscribes to a Series, the subscribers' 1 preferences, etc. Fourth, the fact that a subscriber 1 downloaded a particular file from the host system 14 or a vendor system 18 can be recorded.

Subscriber information can be used in a variety of ways. For example, as more information about a particular subscriber 1 is acquired, the subscriber's 1 interests, preferences, and buying habits, among other things, are revealed. This can be done with the assistance of the host computer 14 and/or statistical analysis. This information can be used to target more appropriately advertisements sent to the subscriber 1 in writings. For example, if the data showed that the subscriber 1 purchased books that included a lot of pictures, advertisements for books with pictures could be sent to the subscriber 1 in writings rather than advertisements for books with mostly text. Thus the advertisements can be directed to the subscriber's interests as revealed by the data. The advertisements may therefore be more successful, because they are tailored to the subscriber's 1 interests. This translates into higher fees that can be charged for advertisements to the subscriber 1 and subscribers 1 with similar profiles, and also into more sales of products or services.

Another way the information can be used is by determining what subscribers 1 subscribed to a particular Series. The backgrounds of this subset of subscribers 1 can be used to provide specific, aggregated, or generalized information as to the interests or the profiles of subscribers 1 interested in the Series (as indicated by the subscription to the Series). As discussed above, the Series may be based on a book(s). Publishers and authors of the book(s) may find it valuable to learn about the subscribers 1 interested in their book(s) (as indicated by the subscribers' 1 subscription to a Series upon which the book(s) is based). Publishers of books and providers of various products and services that in some way relate to the topic of the Series or a writing may find such information to be valuable. They may use such information for various purposes such as to determine how to best market their products and/or services, when to do so, pricing, etc.

Yet another way in which the information can be used is to create subsets of subscribers 1 according to certain criteria. For example, one subset of subscribers 1 could be all subscribers that have subscribed to Series related to topics such as art, music, military battles, gardening, etc. Advertisements for goods and services related to the topic of interest to the subset of subscribers 1 could be targeted to such subset of subscribers. Information about these subsets could also be provided to vendors of products and services relating to the topic so that they could better understand their potential customers.

There are a multitude of ways by which information can be divided and used, only a few of which are described above. Various modifications and improvements thereon will become readily apparent to those skilled in the art.

The order in which each writing in a Series is delivered to subscribers 1 can be modified based on certain criteria. Writings that are more successful than others may be delivered to subscribers 1 prior to those that are less successful. For example, success can be based on how often the writings that are delivered to subscribers 1 are accessed (for example, if writings are delivered via email, whether a subscriber 1 opens the email can be tracked). If certain writings in a Series are accessed more than others, the more frequently accessed writings may be moved ahead of the less frequently accessed writings, so that the next time a Series is subscribed to the more frequently accessed writings are delivered to the subscriber 1 before the less frequently accessed writings. The writings in a Series therefore become self-organizing, with the most accessed writings being delivered prior to the less accessed writings. The writings can be delivered in the order of the most accessed writing to the least accessed writing. This organization of writings can be done in real time. This organization can be done with both Odysseys and Series.

To this point reordering of writings has been discussed in the context of a new subscription to a Series. However, reordering may also be done for a subscriber 1 that is currently receiving a Series. The reordering would be accomplished in the same way as discussed above, except that the subscriber 1 would not receive writings that the subscriber 1 has already received as part of the subscribed to Series. Thus, if a writing was initially ranked first in a Series, and the subscriber 1 received the writing, and after reordering of the writings in the Series the writing was ranked tenth, when the subscriber 1 is slated to receive the tenth writing the subscriber 1 would receive the eleventh writing instead because the subscriber 1 had already received the tenth writing.

Success may also be based on other criteria. For example, the number of advertisements accessed by a subscriber 1 from a particular writing may be tracked, or the number of purchases originating from a particular writing may also be tracked. Those writings with a higher number of advertisements accessed or purchases may be placed ahead of those that are less successful based on this criteria.

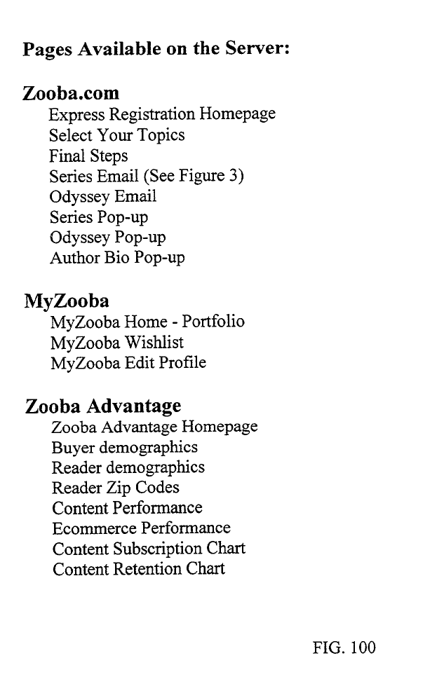

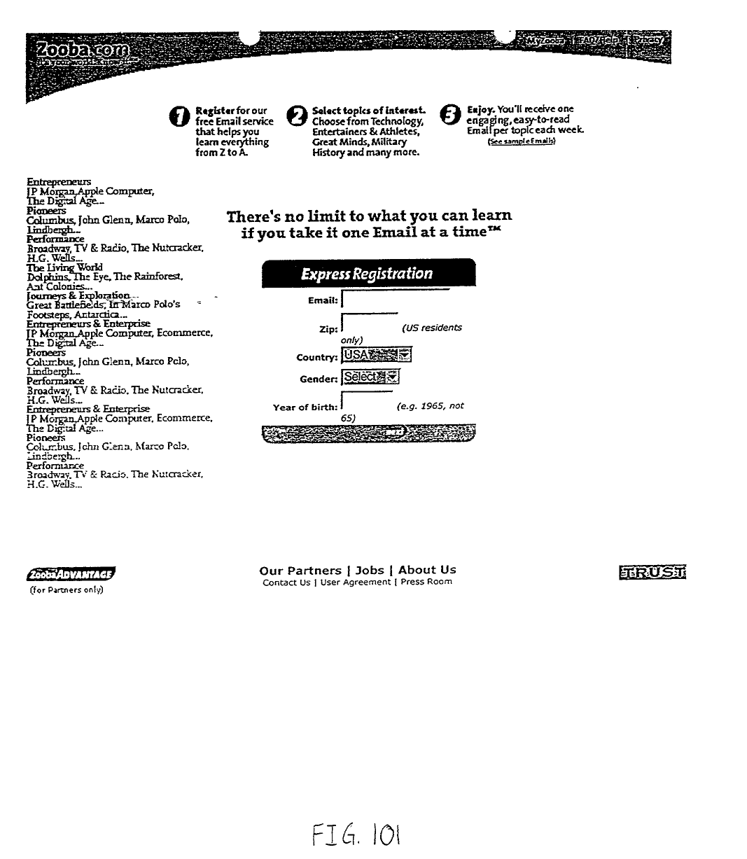

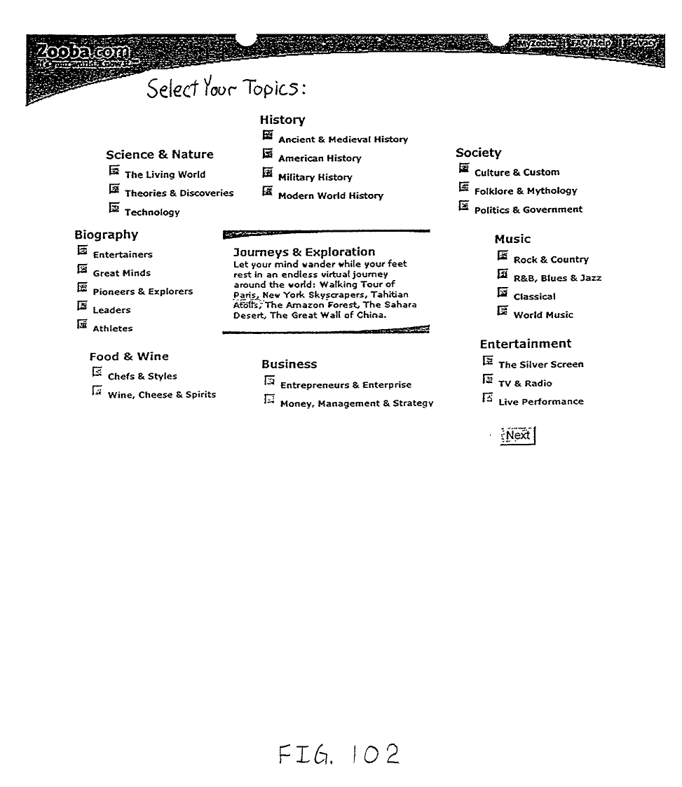

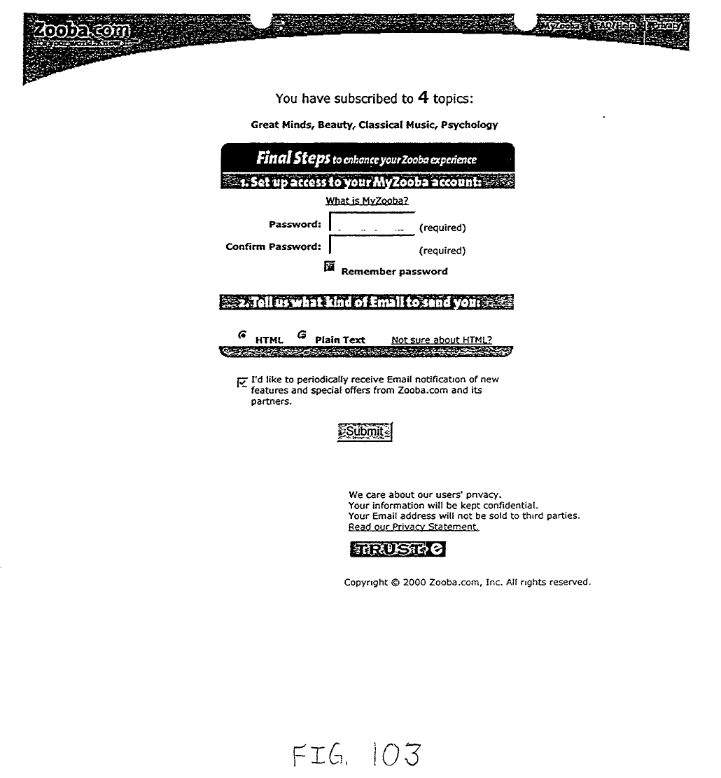

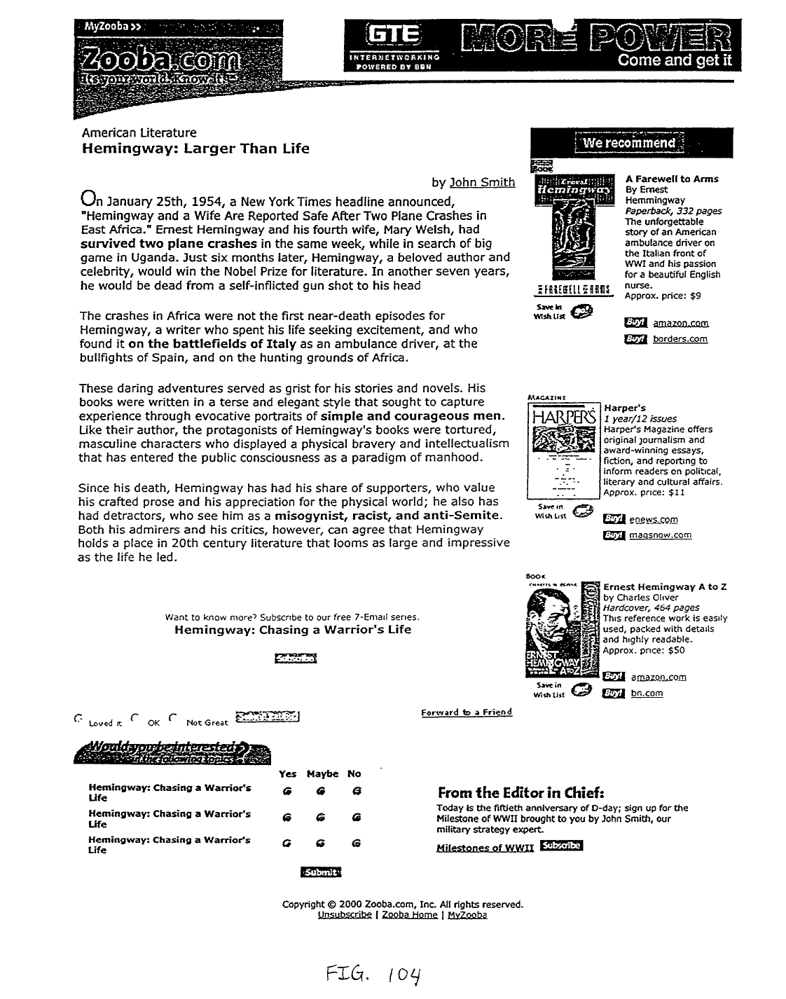

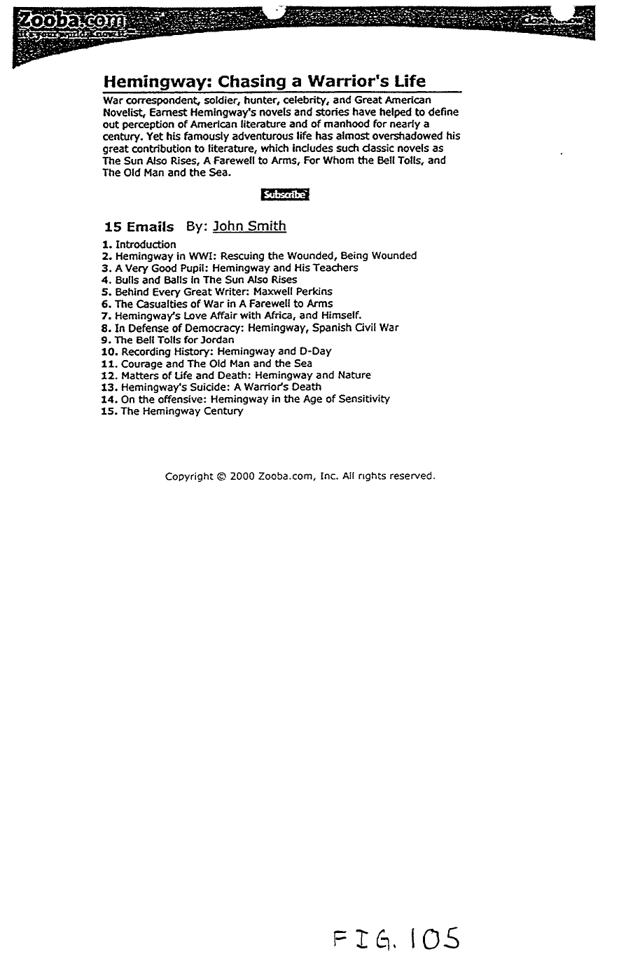

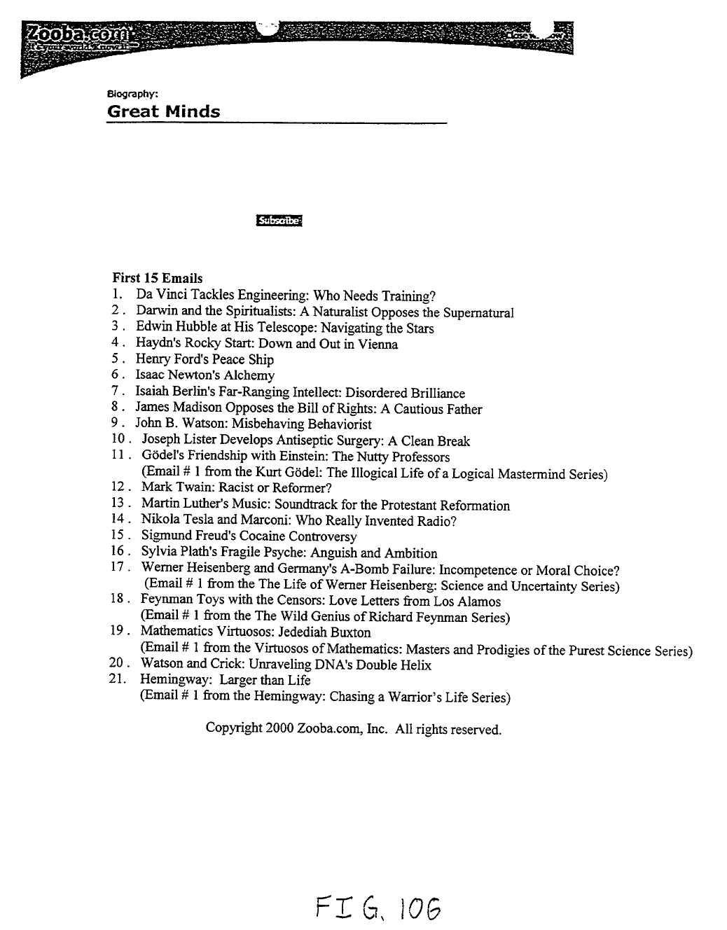

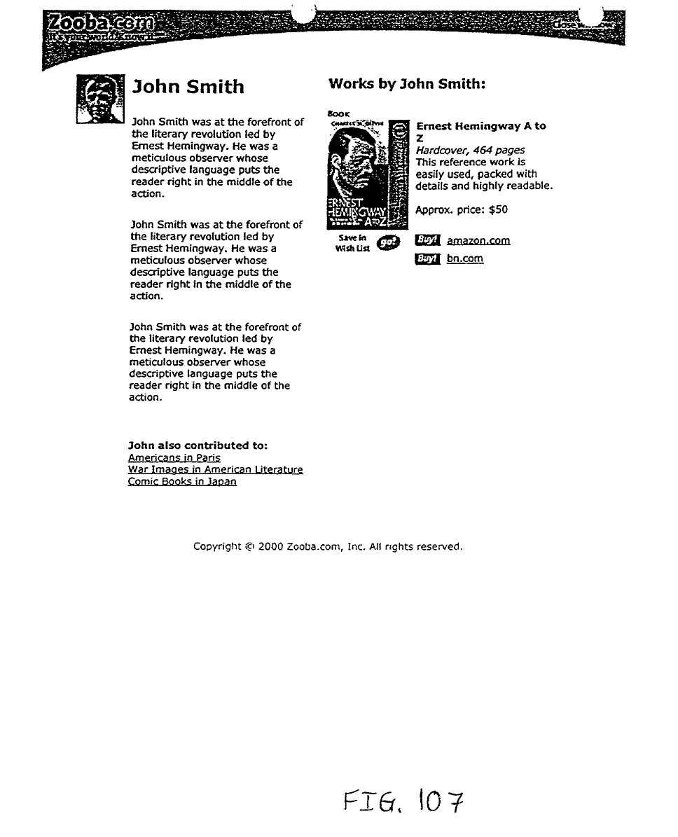

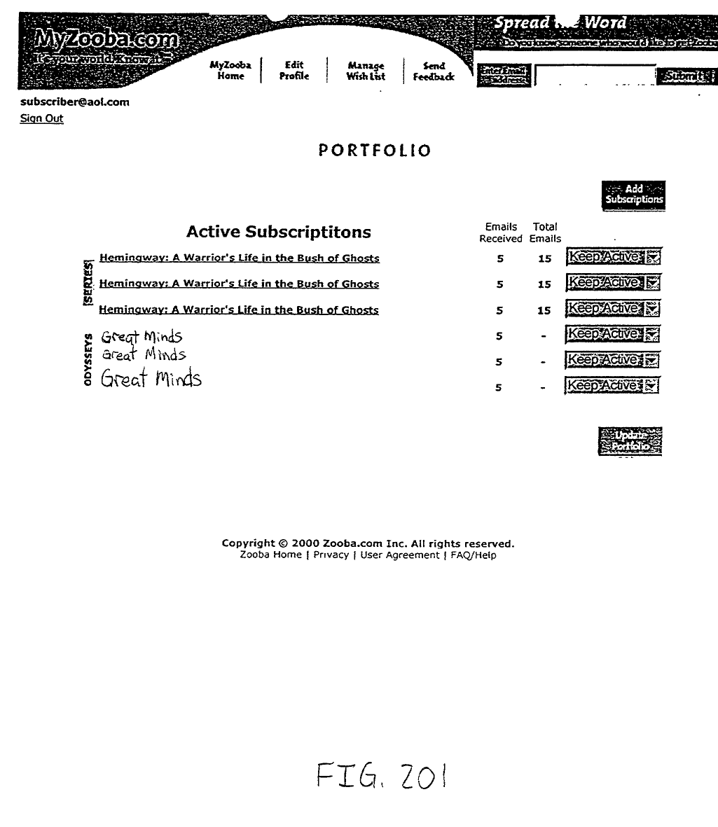

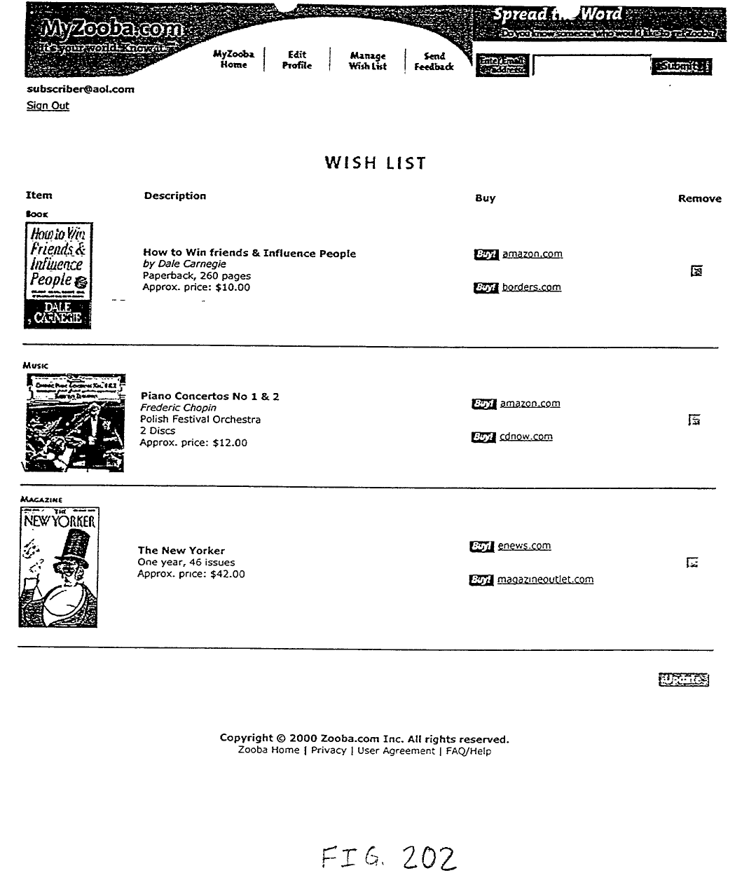

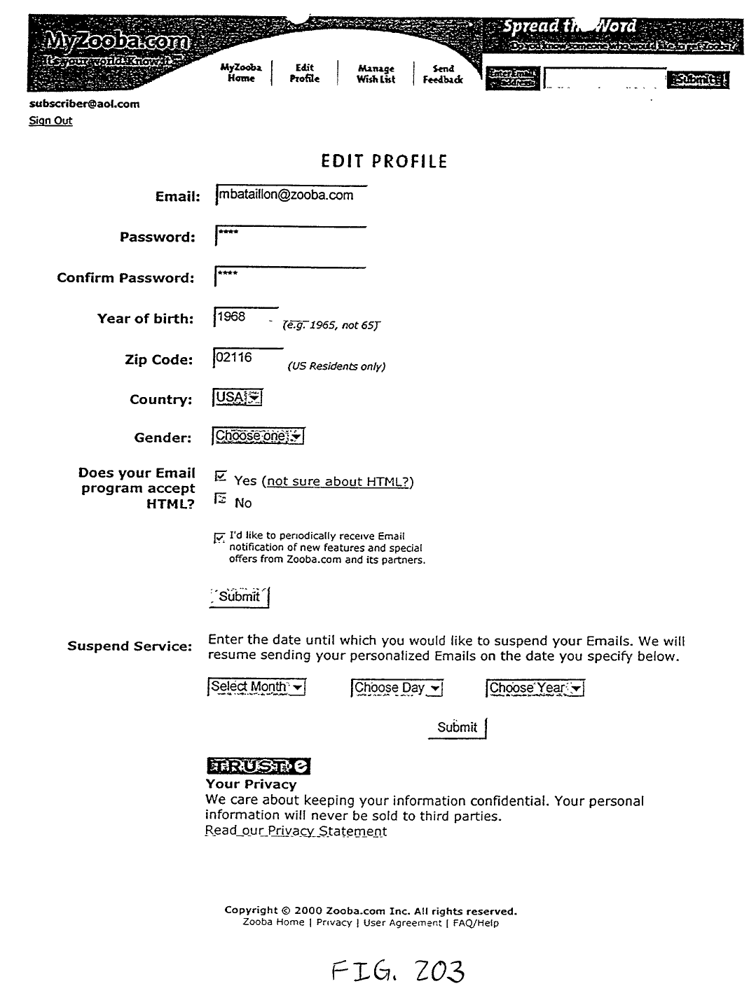

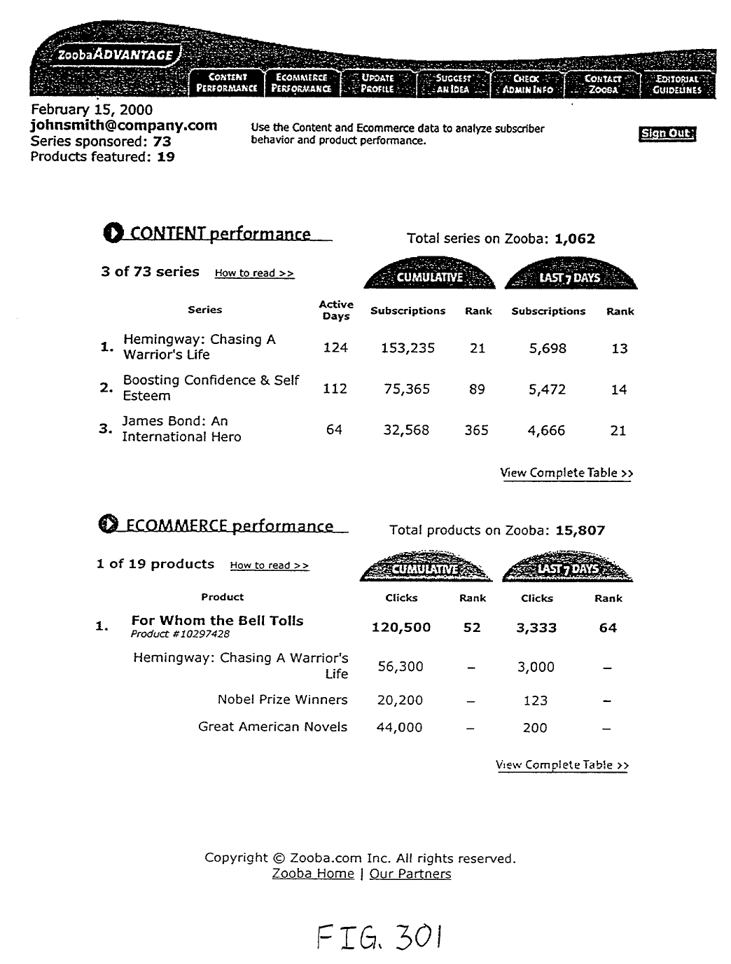

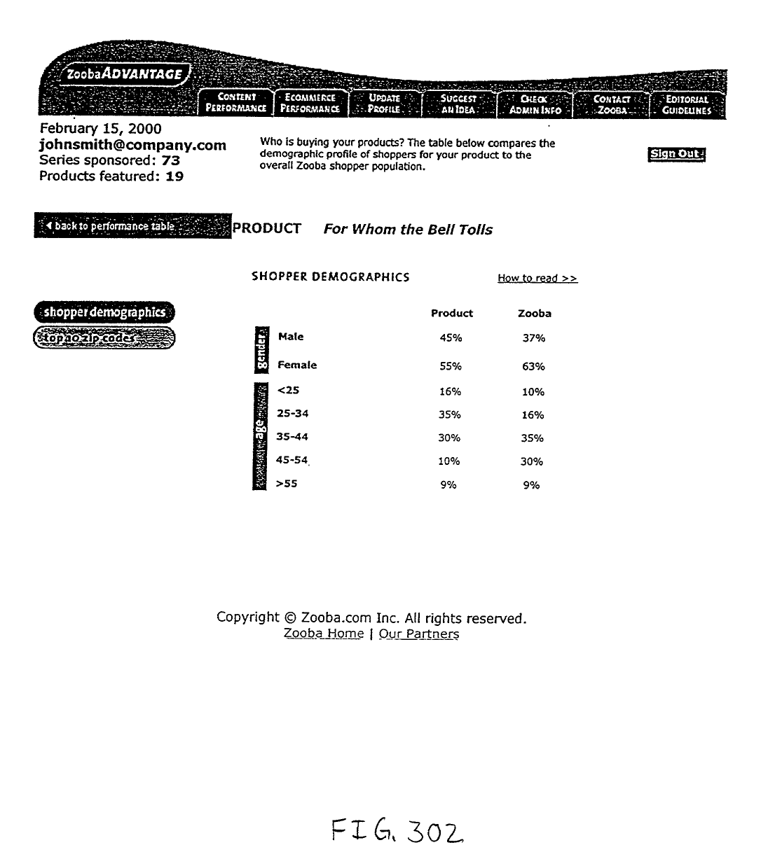

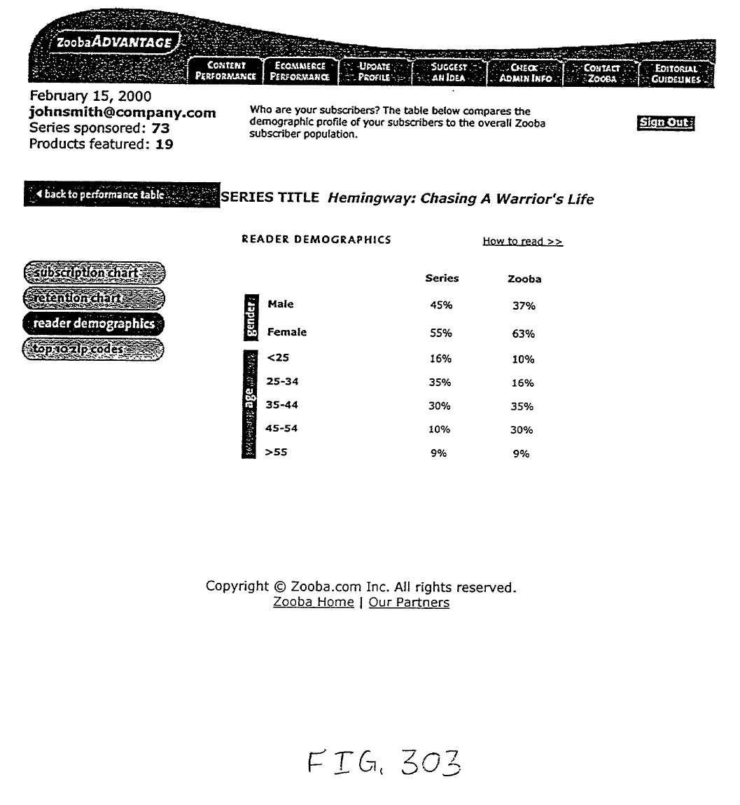

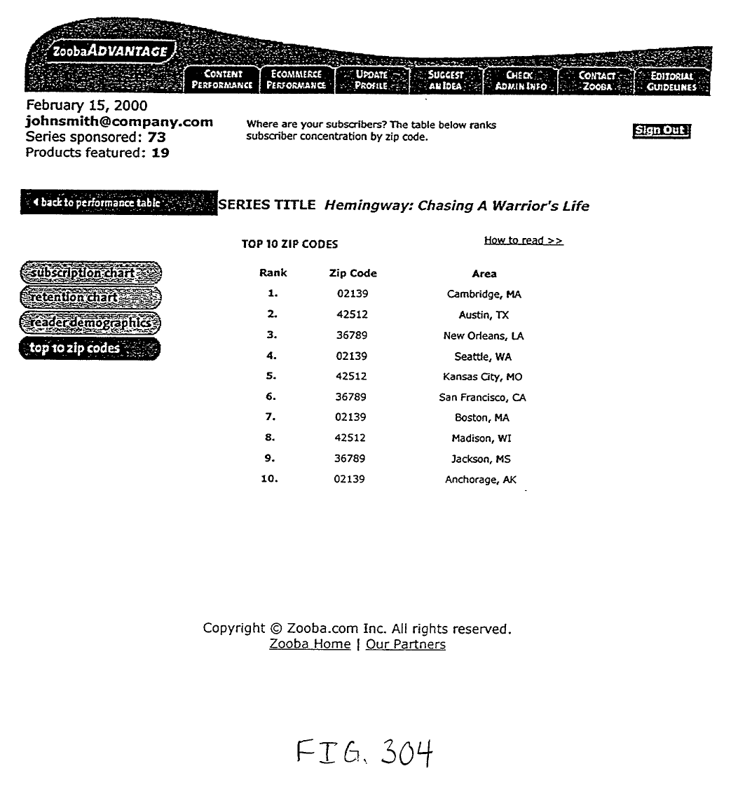

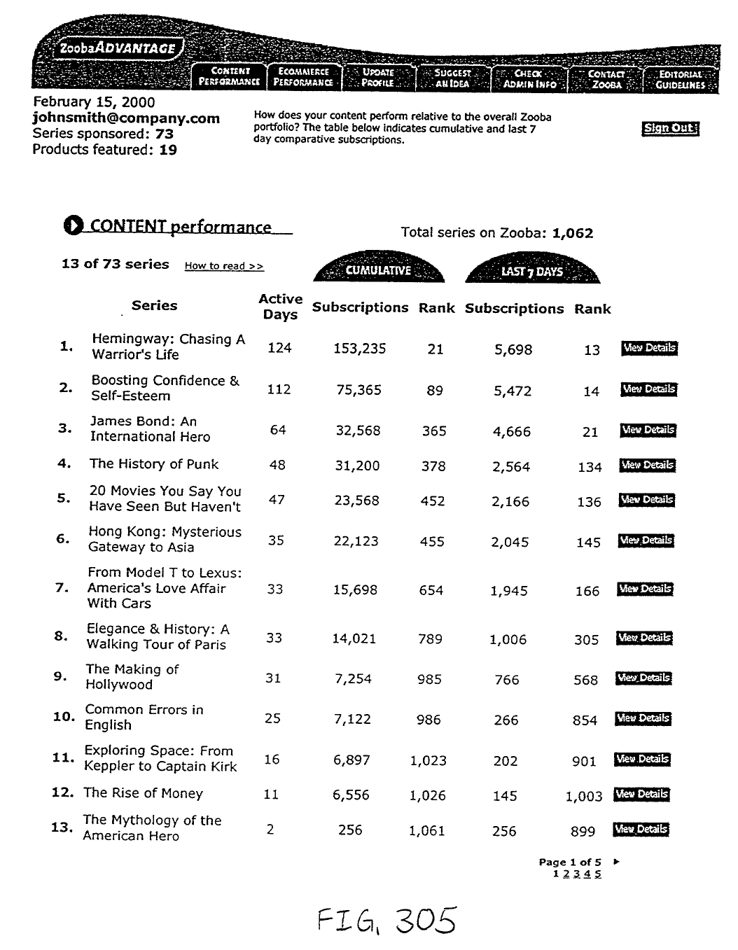

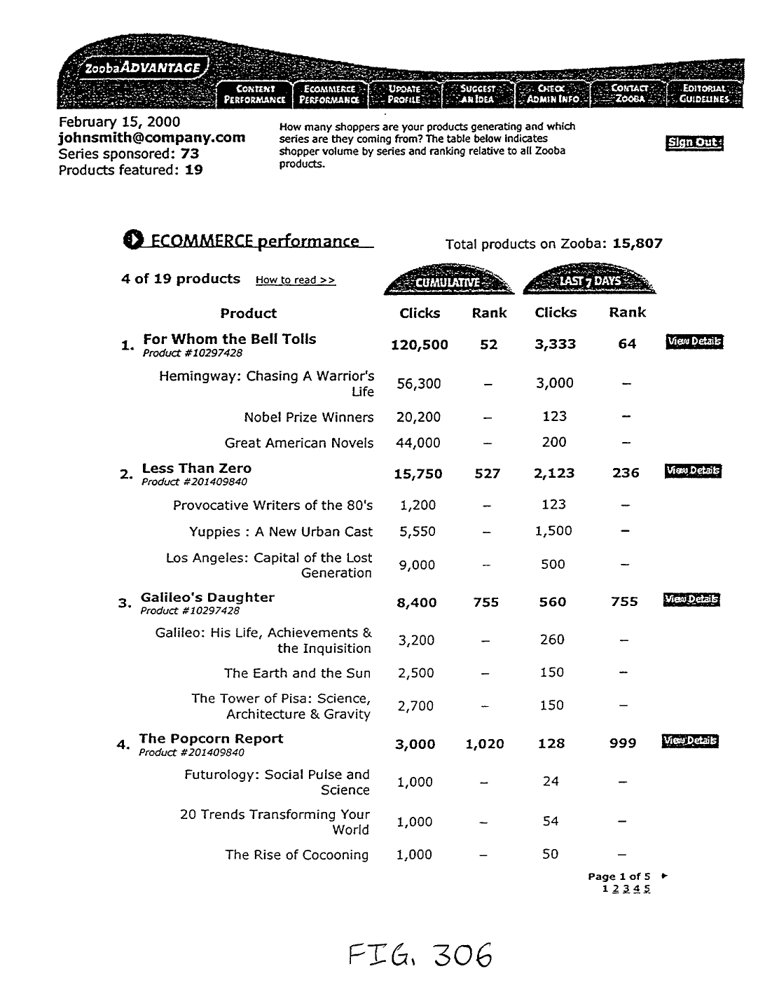

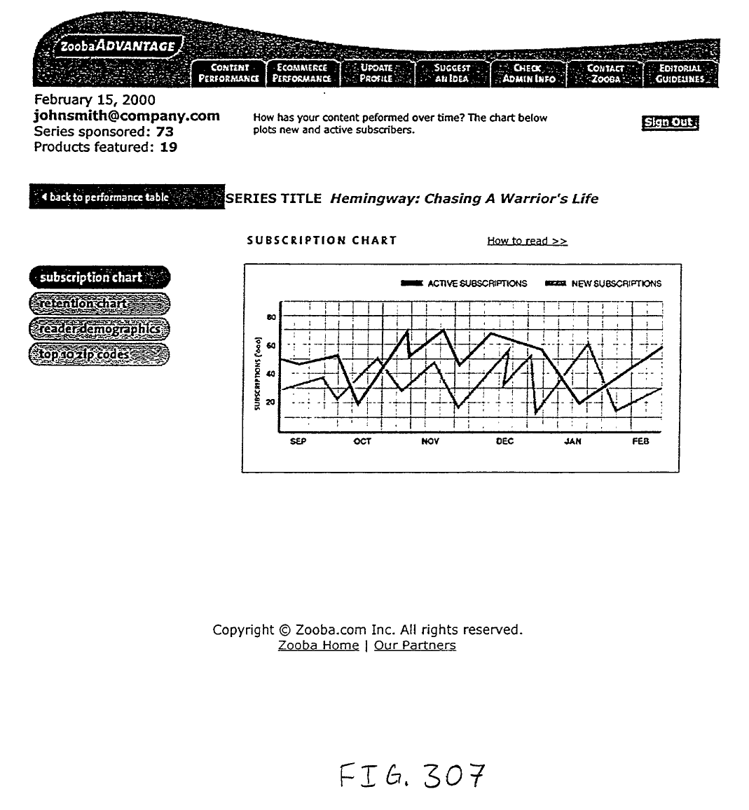

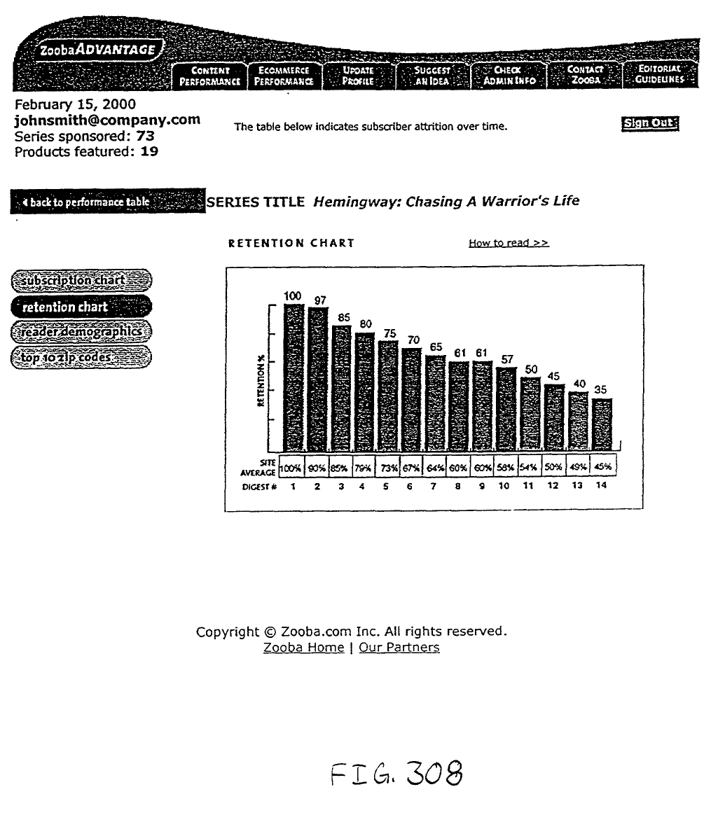

FIG. 100 shows a list of webpages available on a website that constitutes a preferred embodiment of the present invention. FIGS. 101-107 are the webpages referenced under the heading “Zooba.com” in FIG. 100. FIGS. 201-203 are the webpages referenced under the heading “MyZooba” in FIG. 100. FIGS. 301-308 are the webpages referenced under the heading “Zooba Advantage” in FIG. 100. The figures are in order as they appear in FIG. 100.

FIGS. 101-107 are webpages relating to registration and selection of Series, and the Series themselves. FIGS. 201-203 are webpages that a subscriber may use to review and/or modify information in the subscriber's profile. FIGS. 301-308 are webpages that a publisher, for example, might have access to (i) view information on the success of Series (as measured, for example, by the number of subscriptions during a particular period), information on the subscribers viewing such Series (such as, the age and gender of the subscribers for a Series), how the Series is performing in relation to other Series, and the execution of hyperlinks in advertisements and/or sales from advertisements in Series, and (ii) update information about the publisher.

Those skilled in the art will know or be able to ascertain using no more than routine experimentation, many equivalents to the embodiments and practices described herein.

While the invention has been disclosed in connection with the preferred embodiments shown and described in detail, various modifications and improvements thereon will become readily apparent to those skilled in the art. Accordingly, the spirit and scope of the present invention is to be limited only by the following claims.

What is claimed is:

1. A method for delivering content and direct marketing over a network, comprising:
(a) providing a host system and a network;
(b) providing a first connection between the host system and the network and providing a second connection between the network and at least one subscriber system;
(c) providing a plurality of Odyssey topics for selection by a subscriber;
(d) selecting an Odyssey topic and delivering by email from the host system to the subscriber system via the network more than one Odyssey writing on said topic;
(e) providing the subscriber at least one option to subscribe to a Series on the subject matter of at least one Odyssey writing; and
(f) subscribing to a Series and delivering by email from the host system to the subscriber system via the network at least one Series writing.

2. The method of claim 1, further including the step of providing to the subscriber system via the network, with at least one of said Odyssey writings or said at least one Series writing, advertisements or recommendations for products or services, relating to the subject matter of said at least one of said Odyssey writings or said at least one Series writing.

3. The method of claim 2, further including the step of tracking and storing information relating to activities of the subscriber in a subscriber profile, wherein said information is from the group of at least one Series to which the subscriber has subscribed, the topics the subscriber has selected, advertisements the subscriber has viewed, products or services the subscriber has purchased, and any other information that may be stored in a subscriber profile.

4. The method of claim 3, further comprising the step of targeting advertisements or product recommendations to subscribers, based on at least a portion of the information collected relating to subscriber activities.

5. The method of claim 3, further including the step of registering the subscriber, wherein the subscriber provides information from the group of name, address, zip code, age, birthday, interests, income, gender, demographic information, telephone numbers, highest level of education completed, profession, number of people in their home, if they have any children, annual income, interests, hobbies, weight, nationality, and other personal information and storing such information in a subscriber profile.

6. The method of claim 5, further comprising the step of targeting advertisements or product recommendations to the subscriber, based on at least a portion of the information stored in the subscriber profile.

7. The method of claim 6, wherein said at least a portion of the information is from the group of at least one Series to which the subscriber has subscribed, the Series writing topics to which the subscriber has subscribed, and subscriber feedback on at least one Series writing.

8. The method of claim 2, wherein a host enters into an agreement with a vendor whereby the host receives compensation as a result of a subscriber viewing an advertisement or purchasing a product or service.

9. The method of claim 5, further comprising the step of providing to an interested party all, a selection of, the information in the subscriber profile.

10. The method of claim 5, further comprising the step of providing to an interested party all, a selection of, the information in more than one subscriber profile.

11. The method of claim 10, wherein the information provided to the interested party is a generalized or aggregated version of the information in the subscriber profiles.

12. The method of claim 2, wherein said Odyssey writings and said at least one Series writing contain less than 1,000 words each.

13. The method of claim 2, wherein said Odyssey writings and said at least one Series writing are delivered according to the successfulness of said Odyssey writings and said at least one Series writing.

14. The method of claim 13, wherein successfulness is based on the how many times said Odyssey writings and said at least one Series writing have been accessed.

15. A method for delivering content from a host to a subscriber over a network, comprising:
(a) providing a plurality of Odyssey topics for selection by the subscriber;
(b) selecting an Odyssey topic;
(c) receiving via email at least one Odyssey writing on said Odyssey topic;
(d) providing the subscriber an option to subscribe to a Series on the subject matter of at least one Odyssey writing; and
(e) subscribing to a Series and delivering via email at least one Series writing.

16. The method of claim 15, further including the step of tracking and storing information relating to activities of the subscriber in a subscriber profile, wherein said information is from the group of at least one Series to which the subscriber has subscribed, topics the subscriber has selected, advertisements the subscriber has viewed, products or services the subscriber has purchased, and any other information that may be stored in a subscriber profile.

17. The method of claim 16, further including the step of registering the subscriber, wherein the subscriber provides information from the group of name, address, zip code, age, birthday, interests, income, gender, demographic information, telephone numbers, highest level of education completed, profession, number of people in their home, if they have any children, annual income, interests, hobbies, weight, nationality, and other personal information, and storing such information in a subscriber profile.

18. The method of claim 17, further comprising the step of providing to an interested party all, a selection of, the information in the subscriber profile.

19. The method of claim 17, further comprising the step of providing to an interested party all, a selection of, the information in more than one subscriber profile.

20. The method of claim 19, where in the information provided to the interested party is a generalized or aggregated version of the information in the subscriber profiles.

21. The method of claim 17, wherein said more than one Odyssey writings and said at least one Series writing are delivered to the subscriber system by email .

22. The method of claim 19, wherein said more than one Odyssey writings and said at least one Series writing are delivered to the subscriber system by email.

23. A system for delivering content via email over a network, comprising:
(a) a host system for providing Odyssey topics and Series topics over the network; and
(b) a subscriber system connected to the network for receiving from said host system the Odyssey topics and the Series topics for selection by a subscriber, and thereafter receiving from said host system via email at least one Odyssey writing based on a selected Odyssey topic and at least one Series writing based on a selected Series topic.

24. The system of claim 23, wherein at least one Series topic is received by said subscriber system from said host system with said at least one Odyssey writing, and the at least one Series topic is based on the subject matter of said at least one Odyssey writing.

25. The system of claim 24, wherein said host system is designed to send to the subscriber system via the network, with said at least one Series writing, advertisements or recommendations for products or services, relating to the subject matter of said at least one Series writing.

26. The system of claim 25, wherein said host system is designed to track and store information relating to activities of the subscriber in a subscriber profile, wherein said information is from the group of at least one Series to which the subscriber has selected, the topics the subscriber has selected, advertisements the subscriber has viewed, products or services the subscriber has purchased, and any other information that may be stored in a subscriber profile.

27. The system of claim 26, wherein said host system is designed to target advertisements or product recommendations to subscribers, based on at least a portion of the information collected relating to subscriber activities.

28. The system of claim 25, wherein said host system is designed to receive subscriber registration information from the subscriber system, wherein the information is from the group of name, address, zip code, age, birthday, interests, income, gender, demographic information, telephone numbers, highest level of education completed, profession, number of people in their home, if they have any children, annual income, interests, hobbies, weight, nationality, and other personal information and storing such information in a subscriber profile.

29. The system of claim 28, wherein said host system is designed to target advertisements or product recommendations to the subscriber, based on at least a portion of the information stored in the subscriber profile.

30. The system of claim 29, wherein said at least a portion of the information is from the group of at least one Series the subscriber has selected, the Series writing topics the subscriber has selected, and subscriber feedback on at least one Series writing.

31. The system of claim 28, wherein the host system is designed to provide all or a selection of the information in the subscriber profile to a system of an interested third party.

32. The system of claim 28, wherein the host system is designed to provide all or a selection of the information in more than one subscriber profile to a system of an interested party.

33. The system of claim 32, wherein the information provided to the system of the interested party is a generalized or aggregated version of the information in the subscriber profiles.

34. The system of claim 27, wherein said host system is designed to deliver Odyssey writings and said at least one Series writing to the subscriber system according to the successfulness of said Odyssey writings and said at least one Series writing.

35. The system of claim 34, wherein successfulness is based on the how many times said Odyssey writings and said at least one Series writing have been accessed.
